(19) United States
(12) Patent Application Publication
(10) Pub. No.: US 2015/0296575 A1
(43) Pub. Date: Oct. 15, 2015

(54) DRIVER FOR LED LIGHTING AND METHOD OF DRIVING LED LIGHTING

(71) Applicant: VERSITECH LIMITED, Hong Kong (CN)

(72) Inventor: Ron Shu Yuen Hui, Hong Kong (CN)

(21) Appl. No.: 14/443,884

(22) PCT Filed: Nov. 21, 2012
(86) PCT No.: PCT/CN2012/084953

§ 371 Date: May 19, 2015

(51) Int. Cl. H05B 33/08

(52) U.S. Cl. CPC H05B 33/0809; H05B 33/0821

(57) ABSTRACT

The present invention provides a driver for LED lighting having a plurality of LEDs, the driver receiving AC input power from an AC power source and including a voltage multiplier for supplying a rectified output power to the LEDs to produce a luminous flux. Also provided is a method of driving LED lighting having a plurality of LEDs, the method including: receiving AC input power having an input voltage; multiplying the input voltage to supply a multiplied output voltage to the LEDs; and rectifying the AC input power to supply a rectified output power to the LEDs to produce a luminous flux.

### TECHNICAL FIELD

The present invention relates to drivers for LED lighting and methods of driving LED lighting. The present invention is described herein primarily in relation to, but not limited to, high power lighting applications.

### BACKGROUND ART

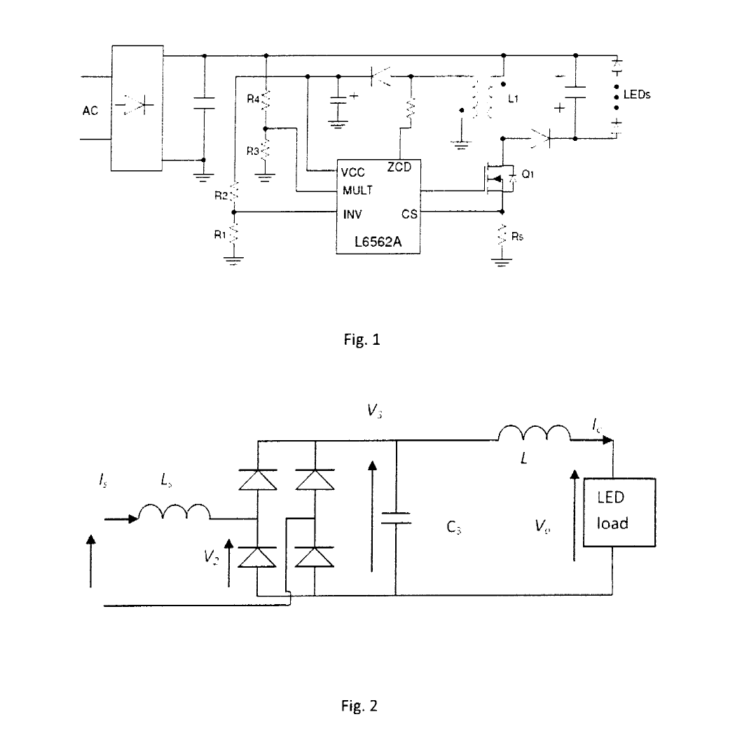

Recent work on LED drivers show that both switched mode LED drivers using active power electronic switches (“active LED drivers”) such as the one shown in FIG. 1 and passive LED drivers without active power electronic switches (“passive LED drivers”) such as the one shown in FIG. 2 have been proposed for LED systems. FIG. 1 shows an “active” offline LED system from the ST Microelectronics Application Notes Power Supply And Power Management L6562A TSM1052 AN2711 Datasheet. For offline applications in which the LED systems are connected to AC mains, active and passive LED drivers essentially turn the AC voltage source at mains frequencies into current sources for driving the LED devices usually connected in series as LED strings.

For compact LED driver designs, the active LED drivers are good solutions. Active LED drivers are based on switched mode power supply technologies. Since the switching frequency could be up to hundreds of kilo-Hertz, the component sizes of the energy storage components such as inductors and capacitors can be reduced. However, due to their requirements for complicated electronic circuitry such as auxiliary power supplies, control integrated circuits, gate drive circuits for power switches, etc., active LED drivers are less reliable in outdoor applications, which are subject to harsh environmental conditions such as wide temperature and humidity changes and lightning.

Passive LED drivers, on the other hand, have simple circuit structures without the need for auxiliary power supplies, control integrated circuits, gate drive circuits for power switches, etc. However, because of mains frequency operation, these passive drivers typically need passive energy storage components of larger size. These components include electrolytic capacitors which have a limited lifetime and are highly sensitive to temperature. Typically, the electrolytic capacitors often used in LED lighting have a lifetime of 15,000 hours or 1.7 years. This lifetime doubles if the operating temperature of the LED lighting is decreased by 10° C, and is halved if the operating temperature is increased by 10° C. Nonetheless, due to their circuit simplicity and robustness against harsh environments, passive LED drivers are more reliable in outdoor applications.

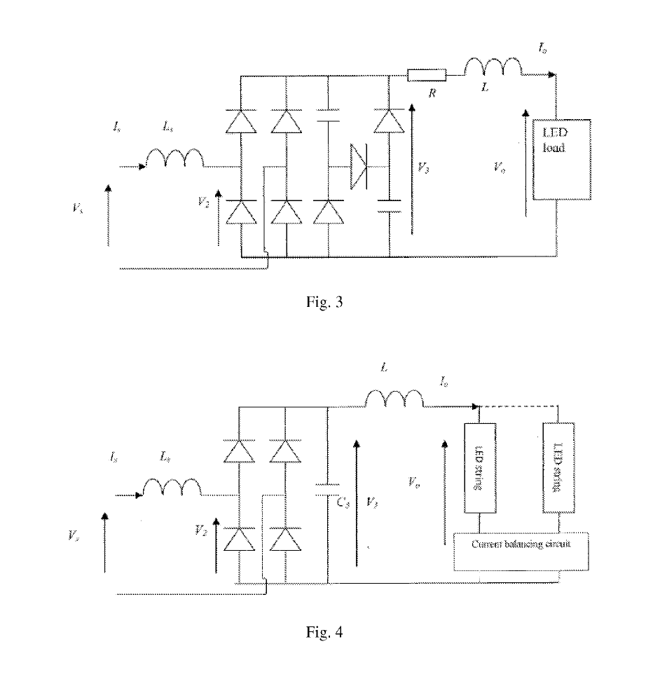

U.S. patent application Ser. No. 13/129,793 describes robust LED drivers for harsh environments which use the passive driver approach without the need for electrolytic capacitors. These passive LED drivers are based on a full-bridge diode rectifier, as shown in FIG. 2. The output voltage of the diode rectifier is smoothed by a nonelectrolytic capacitor C3 and an output inductor turns this capacitor voltage into a current source for driving the LED load. In some cases, the capacitor C3 can be replaced by various forms of valley-fill circuits as shown in FIG. 3.

For high-power LED lighting systems, such as those used in street lighting, LED devices are usually connected in series to form LED strings. If high power is required, it is sometimes necessary to use parallel-connected strings in order to achieve the required power and luminous performance. Since LED devices are not perfectly identical even if they are produced by the same manufacturer, the voltage-current (VI) characteristics of LED devices of the same model type are not exactly identical. Thus, the V-I characteristics of parallel-connected LED strings are also different. Such differences can lead to a current imbalance problem that, in turn, can lead to uneven light and heat distribution, and more importantly, a reduction of the lifetime of LED modules due to unintended over-current situations.

In order to address current imbalance problems with parallel-connected LED strings, various techniques have been proposed, such as those reviewed in “Novel Self-configurable Current Mirror Techniques for Reducing Current Imbalance in Parallel Light-Emitting Diode (LED) strings” authored by Li S.N, Zhong W.Z., Chen W., and Hui S.Y.R. in IEEE Transactions on Power Electronics, Volume: 27, Issue: 4, 2012, Pages: 2153 -2162. In general, current mirror techniques and switched mode current control methods are commonly used for reducing current imbalance in parallel current strings. One current balancing circuit used in such techniques is shown in FIG. 4. However, using these techniques and methods, regardless of their form, will increase circuit complexity and costs.

### DISCLOSURE OF INVENTION

### Technical Problem

It is an object of the present invention to overcome or ameliorate at least one of the disadvantages of the prior art, or to provide a useful alternative.

### SOLUTION TO PROBLEM

### Technical Solution

The present invention provides, in a first aspect, a driver for LED lighting having a plurality of LEDs, the driver receiving AC input power from an AC power source and including a voltage multiplier for supplying a rectified output power to the LEDs to produce a luminous flux.

Preferably, the plurality of LEDs are connected in series.

In various embodiments, the voltage multiplier is one or any combination of: a voltage doubler, a voltage tripler, and a voltage quadruples In some embodiments, the voltage multiplier is one or the combination of: a Delon voltage doubler, and a Greinacher voltage doubler.

Preferably, the driver allows a variation in the rectified output power corresponding to a variation in the luminous flux unnoticeable by a human eye.

Preferably, the driver includes an input capacitor between the AC power source and the voltage multiplier. Preferably, the driver includes an output capacitor between the voltage multiplier and the LEDs. Also preferably, the driver includes an input inductor between the AC power source and the voltage multiplier. Further, the driver preferably includes an output inductor between the voltage multiplier and the LEDs.

In some embodiments, the driver includes a valley-fill circuit between the voltage multiplier and the LEDs.

In some other embodiments, the driver includes a smoothing capacitor between the voltage multiplier and the LEDs.

Preferably, the LEDs are in the form of series-connected strings connected in series. Preferably, the series-connected strings are arranged in parallel.

The present invention also provides, in a second aspect, a method of driving LED lighting having a plurality of LEDs, the method including:

receiving AC input power having an input voltage;

multiplying the input voltage to supply a multiplied output voltage to the LEDs; and

rectifying the AC input power to supply a rectified output power to the LEDs to produce a luminous flux.

Preferably, the plurality of LEDs are connected in series.

In various embodiments, the input voltage is doubled, tripled, or quadrupled. In some embodiments, the input voltage is multiplied using one or the combination of: a Delon voltage doubler, and a Greinacher voltage doubler.

Preferably, the method includes allowing a variation in the rectified output power corresponding to a variation in the luminous flux unnoticeable by a human eye.

### BRIEF DESCRIPTION OF DRAWINGS

### Description of Drawings

Preferred embodiments in accordance with the best mode of the present invention will now be described, by way of example only, with reference to the accompanying figures, in which:

FIG. 1 is a schematic of a prior art offline LED system using an active driver;

FIG. 2 is a schematic of a prior art offline LED system using a passive driver;

FIG. 3 is a schematic of another prior art offline LED system using a passive driver;

FIG. 4 is a schematic of a further prior art offline LED system having parallel-connected LED strings and using a passive driver and a current balancing circuit;

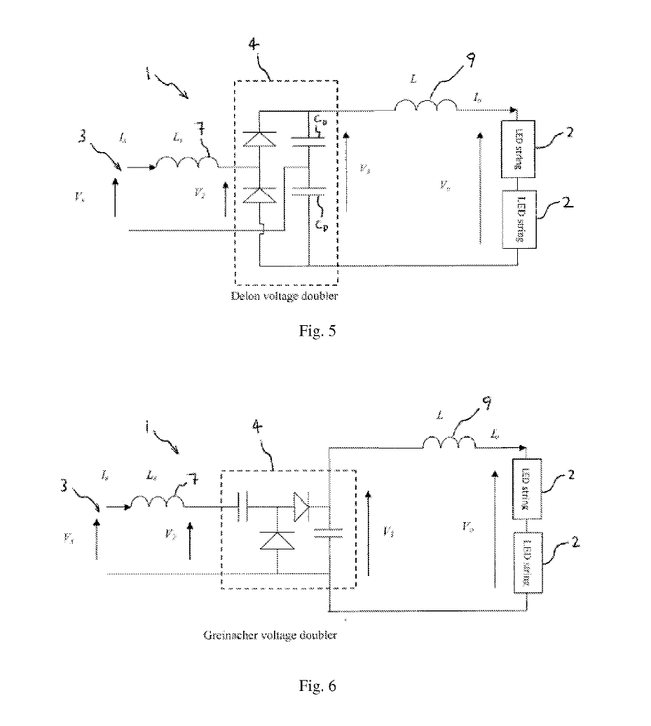

FIG. 5 is a schematic of a driver for LED lighting according to an embodiment of the present invention;

FIG. 6 is a schematic of a driver for LED lighting according to another embodiment of the present invention; and

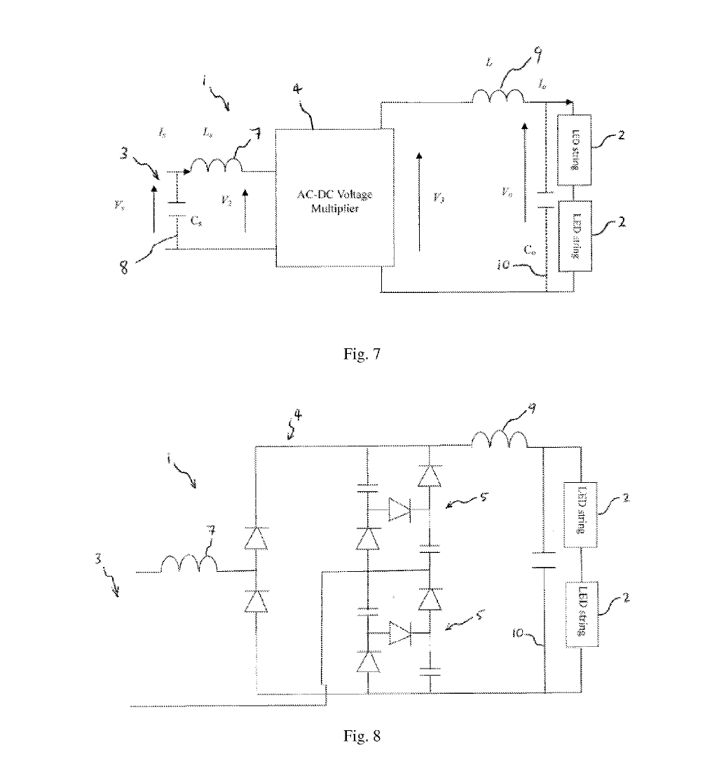

FIG. 7 is a schematic of a driver for LED lighting according to a further embodiment of the present invention;

FIG. 8 is a schematic of a driver for LED lighting according to another embodiment of the present invention; and

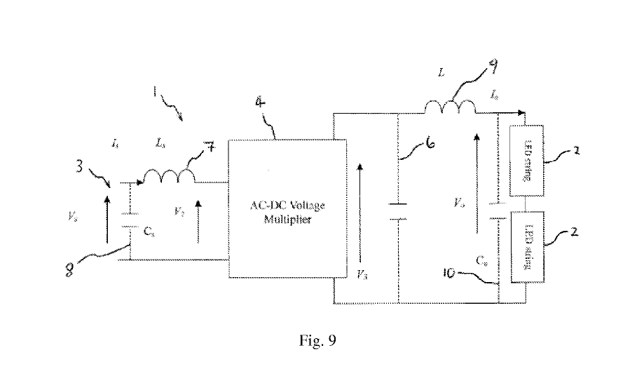

FIG. 9 is a schematic of a driver for LED lighting according to yet another embodiment of the present invention.

### BEST MODE FOR CARRYING OUT THE INVENTION

### Best Mode

Referring to the figures, an embodiment of the present invention provides a driver 1 for LED lighting having a plurality of LEDs 2. The driver 1 receives AC input power from an AC power source 3 and includes a voltage multiplier 4 for supplying a rectified output power to the LEDs 2 to produce a luminous flux.

Depending on the requirements of specific applications, the voltage multiplier can be one or any combination of: a voltage doubler, a voltage tripler, and a voltage quadrupler. For example, in some embodiments, the voltage multiplier is one or the combination of: a Delon voltage doubler, and a Greinacher voltage doubler.

The drivers of the present invention are particularly suited to use as passive LED drivers for high-power applications such as street lighting and other outdoor lighting applications. The drivers provided by the present invention reduce the number of parallel-connected LED strings required, or avoid the need for parallel-connected LED strings altogether. In the latter case, all of the LEDs are connected in series, and therefore, avoid the need for additional circuits, such as current mirror circuits and other current balancing circuits, to prevent the current imbalance problems that occur with parallel-connected LED strings.

It is noted, however, that in the case where all of the LEDs are connected in series, the LEDs can be in the form of a plurality of series-connected LED strings or modules. These LED strings are in turn connected in series, effectively forming a single chain of LEDs all connected in series. However, the series-connected LED strings can be arranged in parallel or any other configuration. Thus, they can replicate any arrangement of parallel-connected LED strings.

In the presently described embodiment of the driver according to the invention, the driver 1 also allows a variation in the rectified output power corresponding to a variation in the luminous flux unnoticeable by a human eye. Embodiments have allowed variations in the luminous flux of up to 12%, and it has been shown that human eyes are not sensitive to variations in luminous flux of such magnitudes.

The variations in rectified output power that correspond to such variations in luminous flux do not require energy storage components of larger size, and in particular, do not require the use of limited lifetime electrolytic capacitors. Thus, drivers of the present invention that allow such variations in rectified output power have been found to be unexpectedly suited to functioning as simple, robust, and reliable passive LED drivers for harsh environments, such as outdoor applications.

Furthermore, in view of the advantages described above of having a voltage multiplier, drivers of the present invention having voltage multipliers that also allow variations in the rectified output power corresponding to unnoticeable variations in luminous flux provide rather surprising and unexpected advantages when used as passive LED drivers for high-power applications in harsh environments, such as outdoor lighting and street lighting applications. In particular, these advantages overcome or ameliorate the problems in such applications that are associated with current imbalance and the limited lifetime of electrolytic capacitors, as discussed in detail above.

The driver 1 allows a variation in the rectified output power corresponding to a variation in the luminous flux unnoticeable by a human eye by, for example, including a valley-fill circuit 5 between the voltage multiplier 4 and the LEDs 2, as shown in FIG. 8. It will be appreciated that in practical implementation, the valley-fill circuit 5 and the voltage multiplier 4 can share some circuit components. Referring to FIG. 5, the voltage multiplier 4 takes the form of a Delon voltage doubler. Each of the two capacitors CD in the Delon voltage doubler are replaced by a valley-fill circuit 5 to result in the driver 1 shown in FIG. 8, thereby including a valley-fill circuit 5 between the voltage multiplier 4 and the LEDs 2.

In another embodiment, instead of the valley-fill circuit 5, a smoothing capacitor 6 is placed across the output of the voltage multiplier 4 between the voltage multiplier 4 and the LEDs 2 in order to allow the variation in the rectified power corresponding to a variation in the luminous flux unnoticeable by a human eye. This is shown in FIG. 9. In this embodiment, the driver 1 also includes an input inductor 7 (Ls) between the AC power source 3 and the voltage multiplier 4. The input inductor 7 is large enough to provide input current filtering, and the input current is primarily sinusoidal and has low current harmonic content. Thus, having the smoothing capacitor 6 replacing the valley-fill circuit 5 is sufficient in allowing the variation in the rectified output power required to produce an unnoticeable variation in the luminous flux.

Other embodiments of the driver 1 include the input inductor 7 (Ls) with or without the valley-fill circuit 5 or the smoothing capacitor 6.

The driver 1 can also include an input capacitor 8 (Cs) between the AC power source 3 and the voltage multiplier 4. The driver 1 also includes an output inductor 9 (L) between the voltage multiplier 4 and the LEDs 2. The input capacitor 8 and the output inductor 9 can be included with our without the valley-fill circuit 5 and/or the smoothing capacitor 6. Where the smoothing capacitor 6 is included, it is placed between the voltage multiplier 4 and the output inductor 9.

The present invention also provides a method of driving LED lighting having a plurality of LEDs. Embodiments of the method will be readily apparent from the description above. For example, referring to the figures, an embodiment of the method includes: receiving AC input power having an input voltage; multiplying the input voltage to supply a multiplied output voltage to the LEDs 2; and rectifying the AC input power to supply a rectified output power to the LEDs 2 to produce a luminous flux.

In some embodiments, the method includes allowing a variation in the rectified output power corresponding to a variation in the luminous flux unnoticeable by a human eye.

Considering the figures in more particular detail, FIG. 7 shows the basic structure of an offline passive LED system in accordance with the present invention. The input capacitor 8 (Cₛ) can be added as a power correction capacitor. An output capacitor 10 (C_{O}) in the form of a small capacitor can be added across the output terminal for providing a continuous current path for the output inductor current in case there is an open circuit fault in the string of LEDs 2. In particular, the output capacitor 10 is placed between the output inductor 9 and the LEDs. As noted above, the voltage multiplier can be a voltage doubler, or if more power and luminous output is needed for the offline passive LED system, the voltage multiplier concept can be extended to a voltage tripler and a voltage quadrupler.

As explained previously, the use of parallel LED strings is to increase the output power and thus luminous output of LED lighting systems. For passive LED drivers, the rectified output voltage of the diode rectifier is related to the input voltage of the AC mains. Such DC voltage sets a limit on the number of series-connected LED modules in each LED string that are possible. For example, if the output DC voltage is 150 V and the voltage and current ratings of each series-connected LED module is 10 V and 0.35 A respectively, then each LED string can consist of 15 series-connected LED modules and the power of each string is 52.5 W. Therefore, for LED systems of nominal power of 100 W and 150 W, two and three LED strings will be needed, respectively, if the same output voltage of the passive LED driver is employed. FIG. 4 illustrates the use of parallel-connected LED strings to expand the power output.

The simplest way to eliminate current imbalance is of course to use a single string. However, passive LED drivers based on the use of full wave diode rectifiers and an input inductor Lₛ, as depicted in FIG. 2 and FIG. 3, have some limitations in terms of the output voltage. Therefore, the passive LED drivers of FIGS. 2 to 4 are not suitable for single LED string applications unless the power of the single LED string can meet the power and luminous performance required by the LED lighting system.

Instead of using parallel-connected strings for the same DC voltage output provided by the passive LED driver, the present invention uses a voltage multiplier to provide a scalable DC output voltage for series-connected LED strings (to form one single LED string).

FIG. 5 shows a specific example of using an AC-DC voltage doubler in the form of a Delon voltage doubler (enclosed in the dotted box) as the voltage multiplier 4. The output voltage of voltage doubler in FIG. 5 is twice the output voltage of the full-bridge diode rectifier of FIG. 4. As a result, the power of two LED strings can be met by having the two LED strings connected in series, effectively forming a single LED string with twice the power of the original string. Other forms of voltage doublers such as the Greinacher voltage doubler can also be used for doubling the output voltage. FIG. 6 shows a driver with a Greinacher voltage doubler.

As described above, the present invention is directed to circuit topologies and methods of operation of LED drivers for powering only a single lighting-emitting diode (LED) string. While high-power LED systems normally have the LEDs arranged in parallel-connected strings, the use of one LED string can eliminate the current imbalance problems that occur among parallel-connected LED strings. The present invention describes how passive LED drivers, that do not need auxiliary power supplies, active semiconductor switches and control integrated circuits, can be designed to cope with high-voltage and low-current requirements in a single LED string arrangement. With the use of a single-string LED arrangement, the requirements for balancing parallel LED string currents can be eliminated.

The present invention is also directed to drivers that allow a variation in rectified out power that corresponds to a variation in luminous flux produced by the LEDs unnoticeable by a human eye. This alleviates the need to use limited lifetime electrolytic capacitors in the drivers, which results in robust and reliable drivers with much longer lifetimes. Such drivers are especially suited to harsh environments, such as those encountered in outdoor lighting and street lighting applications.

This, the combination of features of the present invention provides robust and reliable LED drivers having long lifetimes that do not require current balancing techniques and their associated circuitry. The present invention is therefore particularly suitable for, but not restricted to, high-power LED lighting applications such as outdoor and street lighting.

Although the invention has been described with reference to specific examples, it will be appreciated by those skilled in the art that the invention can be embodied in many other forms. It will also be appreciated by those skilled in the art that the features of the various examples described can be combined in other combinations.

1-18. (canceled)

19. A driver for LED lighting having a plurality of LEDs, the driver receiving AC input power from an AC power source and including a voltage multiplier for supplying a rectified, output power to the LEDs to produce a luminous flux.

20. A driver according to claim 19 wherein the plurality of LEDs are connected in series.

21. A driver according to claim 19 wherein the voltage multiplier is one or any combination of: a voltage doubler, a voltage tripler, and a voltage quadrupler.

22. A driver according to claim 19 wherein the voltage multiplier is one or the combination of: a Delon voltage doubler, and a Greinacher voltage doubler.

23. A driver according to claim 19 wherein the driver allows a variation in the rectified output power corresponding to a variation in the luminous flux unnoticeable by a human eye.

24. A driver according to claim 19 comprising an input capacitor between the AC power source and the voltage multiplier.

25. A driver according to claim 19 comprising an output capacitor between the voltage multiplier and the LEDs.

26. A driver according to claim 19 comprising an input inductor between the AC power source and the voltage multiplier.

27. A driver according to claim 19 comprising an output inductor between the voltage multiplier and the LEDs.

28. A driver according to claim 19 comprising a valley-fill circuit between the voltage multiplier and the LEDs.

29. A driver according to claim 19 comprising a smoothing capacitor between the voltage multiplier and the LEDs.

30. A driver according to claim 19 wherein the LEDs are in the form of series-connected strings connected in series.

31. A driver according to claim 30 wherein the series-connected strings are arranged in parallel.

32. A method of driving LED lighting having a plurality of LEDs, the method including:
receiving AC input power having an input voltage;
multiplying the input voltage to supply a multiplied output voltage to the LEDs; and
rectifying the AC input power to supply a rectified output power to the LEDs to produce a luminous flux.

33. A method according to claim 32 wherein the plurality of LEDs are connected in series.

34. A method according to claim 32 wherein the input voltage is doubled, tripled, or quadrupled.

35. A method according to claim 32 wherein the Input voltage is multiplied using one or the combination of; a Delon voltage doubler, and a Greinacher voltage doubler.

36. A method according to claim 32 comprising allowing a variation in the rectified output power corresponding to a variation in the luminous flux unnoticeable by a human eye.
